(19) United States
(12) Patent Application Publication
(10) Pub. No.: US 2009/0164809 A1
(43) Pub. Date: Jun. 25, 2009

(54) POWER SUPPLY TESTING ARCHITECTURE

(75) Inventor: Jin-Ki Kim, Ottawa (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: MOSAID TECHNOLOGIES INCORPORATED, Kanata, ON (CA)

(21) Appl. No.: 12/294,270

(22) PCT Filed: Mar. 8, 2007
(86) PCT No.: PCT/CA2007/000382

§ 371 Date: Sep. 24, 2008

(30) Foreign Application Priority Data
Mar. 27, 2006 (CA) 2, 541, 046

(51) Int. Cl. G06F 1/26

(52) U.S. Cl. 713/300

(57) ABSTRACT

A power supply testing architecture for embedded sub-systems is described, where each embedded sub-system can have at least one testable internal voltage supply. A plurality of embedded sub-systems are organized into groups, where each group of sub-systems shares a common voltage test line connected to the internal voltage supplies of the sub-systems. Accordingly, the collective internal voltages of each group can be tested in parallel. A power control signal can disable the internal voltage supply of all the sub-systems to allow application of an external power to the common voltage test lines. Alternately, the sub-systems in each group can be tested sequentially, such that each enabled sub-system of the group has dedicated access to its common voltage test line. In such a scheme, dedicated power control signals are used to independently disable each sub-system of the groups.

### TECHNICAL FIELD

The present invention generally relates to power supply testing architectures. In particular, the present invention relates to architectures for testing multiple power supplies in a system.

### BACKGROUND INFORMATION

Today's electronic devices, such as mobile phones for example, are being pushed to provide higher performance in smaller form factor products. Accordingly, the semiconductor chips providing the processing functionality of these devices, previously implemented as discretely packaged components, are now being integrated all together into a single system on chip device (SOC). Not only does such integration reduce the required board space occupied by the system over a system implemented with discrete components, performance is improved. Higher data bandwidth within the SOC is possible, while pin inductance and signal routing between components is eliminated.

These functional sub-systems of the SOC, which can include embedded Flash, SRAM and/or DRAM memory and processor cores, may require the use of internal power supplies local to that sub-system. Ideally, the internal power supplies will generate the required internal voltage accurately. However, due to variations in advanced semiconductor fabrication processes, the actual power supply level being generated is not at the nominally required level. Hence these power supplies are typically tested by monitoring the power supply level via test pads or pins, and adjusted by fuses to maximize yield and reliability. The SOC package may not have sufficient pads or pins dedicated to this testing or monitoring scheme. Thus, additional silicon areas are required for test pads and dedicated physical lines, resulting in increase in the system cost.

### SUMMARY OF THE INVENTION

It is an object of the present invention to provide an improved architecture for testing multiple power supplies in a system.

In one aspect, the present invention provides a power supply test architecture for a system having two internal power supplies, comprising: a bi-directional voltage test line connected to the two power supplies; and a power control signal for disabling at least one of the two internal power supplies.

For example, the two internal power supplies are configured for generating identical internal voltages and are integrated in first and second sub-systems. The power control signal simultaneously or separately disables the two internal power supplies.

Advantageously, the power supply test architecture further includes isolation means for selectively connecting one of the two internal power supplies to the bi-directional voltage test line in response to at least one selection signal.

In another aspect, the present invention provides a power supply test architecture comprising: a plurality of sub-systems, each of the plurality of sub-systems having an internal power supply for providing an internal voltage; a plurality of voltage test lines, each of the plurality of voltage test lines receiving the internal voltage from corresponding groups of sub-systems; and a power control signal for disabling at least one of the internal power supplies in the corresponding groups of sub-systems.

For example, a plurality of embedded sub-systems are organized into groups, where each group of sub-systems shares a common voltage test line connected to the internal voltage supplies of the sub-systems. Advantageously, the collective internal voltages of each group are tested in parallel. A power control signal can disable the internal voltage supply of all the sub-systems to allow application of an external power to the common voltage test lines. Alternately, the sub-systems in each group are tested sequentially, such that each enabled sub-system of the group has dedicated access to its common voltage test line. In such a scheme, dedicated power control signals are used to independently disable each sub-system of the groups.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of a sub-system having multiple internal power supplies;

FIG. 2 is a block diagram of a power supply testing architecture for embedded DRAM macro sub-systems;

FIG. 3A is a block diagram of a power supply testing architecture for sub-systems, according to an embodiment of the present invention;

FIG. 3B illustrates a DRAM macro representing DRAM macro's used in the power supply testing architecture of the embodiments according to the present invention;

FIG. 4 is a block diagram of a common power control signal testing architecture according to an embodiment of the present invention;

FIG. 5 is a block diagram of a selective power control signal testing architecture according to an embodiment of the present invention; and,

FIG. 6 is a block diagram of a common voltage test line testing architecture according to an embodiment of the present invention.

### DETAILED DESCRIPTION

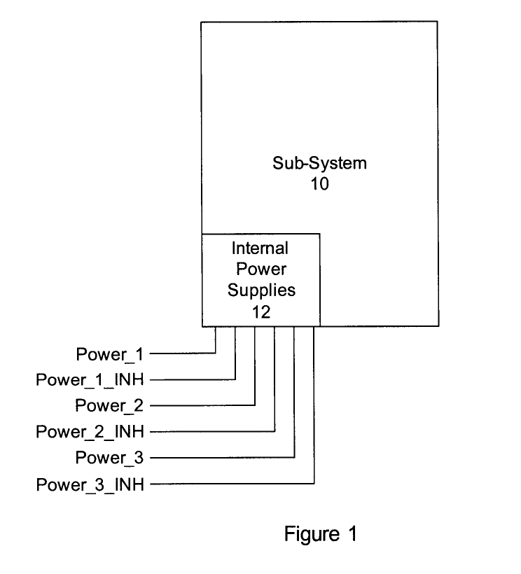

FIG. 1 illustrates a generic sub-system. Referring to FIG. 1, a sub-system 10 has an internal power supply circuit area 12. In the presently shown example, sub-system 10 has three different internal power supply generator circuits. Therefore, in order to test the each power supply, physical lines are connected between each power supply and a test pad or pin. In FIG. 1, these physical lines are labeled Power_1, Power_2 and Power_3. Connected to each power supply are inhibit control signals Power_1_INH, Power_2_INH, and Power_3_INH for selectively turning off its respective power supply. These inhibit control signals can be connected by physical lines to respective test pads or pins.

An example sub-system frequently used in SOC systems is embedded DRAM. Embedded DRAM is typically instantiated in a system as individual macros, where each macro can have a predefined density and size. Collectively, the instantiated macros provide a total storage density usable by one or more applications of the SOC system. Those skilled in the art will understand that embedded DRAM can require four different internally generated power supplies, each being generated by respective internal power generator circuits. In particular, these power supplies include a voltage higher than the normal supply called VPP, a bitline precharge voltage VBLP, a cell plate voltage for the DRAM cells called VCP, and a substrate back-bias voltage VBB. Accordingly, there are four respective voltage inhibit control signals that are required. This list of voltages is not meant to be comprehensive, as different memory architectures can use a variety of different internal voltages.

The internal power supplies of each sub-system are preferably tested after fabrication to ensure that each voltage generator is producing the optimal voltage level. Furthermore, each power supply can be forced externally for testability and design verification by disabling it via the appropriate inhibit control signal. The inhibit control signals ensure that there is no “fighting” between the internal power supply output and the external voltage source.

During testing, any voltage generator that is not generating the optimal voltage level is adjusted, or trimmed, by blowing fuses, anti-fuses or by any other suitable programming means. Hence, the yield and reliability of each sub-system can be maximized.

The most straightforward solution for testing the power supplies of each sub-system, is to include dedicated inhibit and power pads for each sub-system. However, this would result in too many power and inhibit lines, as well as test pads or pins. Those skilled in the art will understand that the routing of physical lines and test pads occupy silicon area, which ultimately increases the overall cost of the system. For example, an SOC having eight embedded DRAM macros each with four internal power supply generator circuits and four inhibit control inputs will require eight macros×eight lines=sixty-four physical lines and corresponding pins or test pads. The SOC package may not have sufficient pins dedicated to this testing scheme, and the additional silicon area required for test pads and dedicated physical lines may increase the system cost.

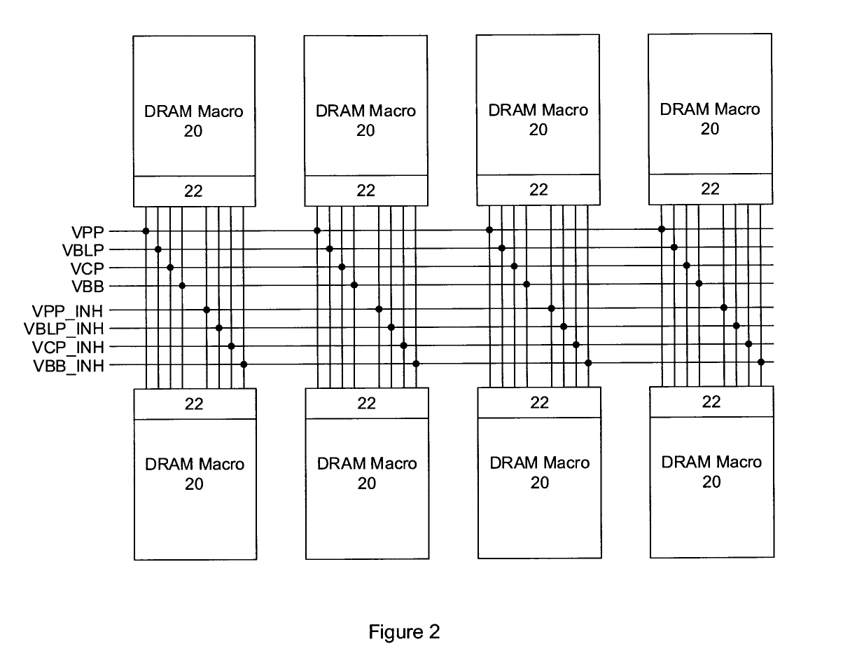

One possible power supply testing architecture is illustrated in FIG. 2. In this example, eight embedded DRAM macros 20 are instantiated in the system chip. Each macro 20 has an internal power supply circuit area 22. The size of internal power supply circuit area 22 relative to DRAM macro 20 is not intended to be accurate or to scale. The VPP, VBLP, VCP and VBB test outputs from each DRAM macro 20 are commonly connected across the system chip, as are the inhibit control signals VPP_INH, VBLP_INH, VCP_INH and VBB_INH. Therefore, the four internal power supply generator circuits of all eight DRAM macros 20 can be simultaneously monitored.

Although the testing architecture of FIG. 2 minimizes the number of test pins to eight, each internal power supply in each embedded DRAM macro cannot be tested separately. This is significant since there is likely to be variations of output voltage levels across the system chip, due to manufacturing variation. This is known in the art as across chip variation, or ACV. With advanced process technologies at the sub-100 nm level, ACV becomes more pronounced. In the testing architecture of FIG. 2 for example, if the DRAM macros 20 are manufactured using advanced processes, the left-most and right-most DRAM macros 20 can have output voltages that differ by 200 mV. It is noted that this variance can depend on a variety of factors, hence the 200 mV difference is merely exemplary. However, since the same voltage output is connected in common to multiple DRAM macros 20, the testing will not indicate which DRAM macro's 20 are generating improper voltages.

Therefore, it is desirable to have a testing architecture that minimizes the required number of test pins while allowing accurate testability of each sub-system in the system.

A power supply testing architecture for embedded sub-systems will now be described, where each embedded sub-system can have at least one testable internal voltage supply. A plurality of embedded sub-systems are organized into groups, where each group of sub-systems shares a respective common voltage test line connected to the internal voltage supplies of the sub-systems. Accordingly, the collective internal voltages of each group are tested in parallel. A power control signal can disable the internal voltage supply of all the sub-systems to allow application of an external power to the common voltage test lines. Sub-systems can include embedded DRAM or Flash memory, or any type of integrated circuit having internal power supplies.

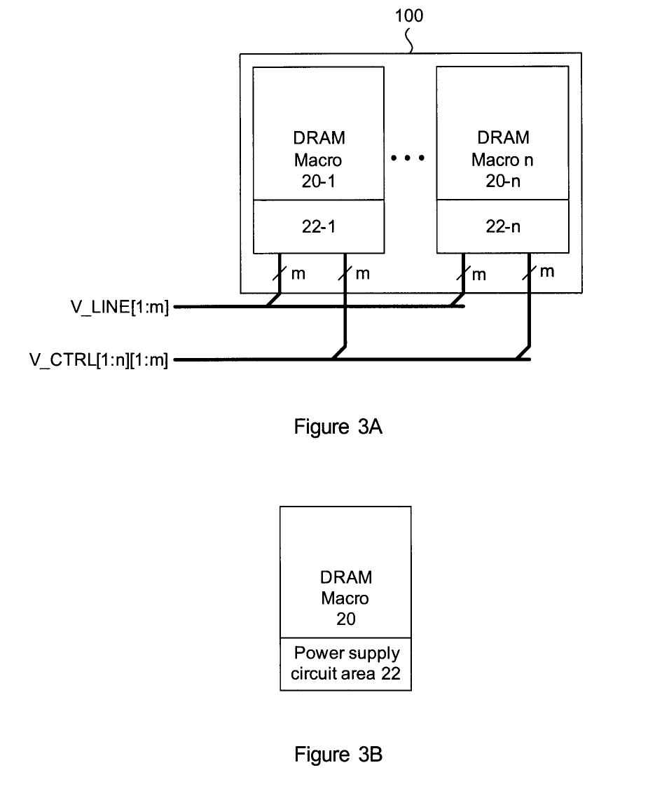

FIG. 3A is a block diagram illustrating an embodiment of the present invention. In particular, FIG. 3A shows one grouping of sub-systems 100, shown here using embedded DRAM macro's 20-1 to 20-n. Those skilled in the art will understand that FIG. 3A can just as easily be implemented with other types of sub-systems, such as Flash memory. In the embodiments described hereinafter, DRAM macro's are represented by a DRAM macro 20 having an internal power supply circuit area 22 as shown in FIG. 3B.

In a system having many embedded DRAM macro's 20, each grouping is identically configured according to the present embodiment of the invention. The presently shown grouping 100 can include “n” embedded DRAM macro's 20. Each embedded DRAM macro 20 has its own corresponding internal power supply circuit area 22, which can have “m” internal power supplies. In the present context, an internal power supply in an embedded macro refers to power supplies that provide voltages locally within the macro, and are not shared between other instances of embedded macros. Variables “n” and “m” are integer values greater than zero. In one scheme to test each power supply, there are “m” voltage test lines, which are connected between the internal power supplies and a common bus labeled V_LINE[1:m]. Each voltage test line of V_LINE[1:m] can be terminated at a test pad or bond pad. To disable the internal power supplies of each embedded DRAM macro 20, each DRAM macro 20 receives “m” power control signals. A signal bus labeled V_CTRL[1:n][l:m] can carry “n” different sets of “m” power control signals, or alternatively, can carry one set of “m” power control signals. The selection of the appropriate power control signal distribution scheme will be discussed in further detail below.

As previously mentioned, ACV can affect the actual output voltage generated by the internal power supplies in different embedded DRAM macro's 20. Generally, it is known to those in the art that adjacent macro's 20 will not be significantly affected by ACV. However, depending on the technology process being used, the ACV may not significantly affect several adjacent macro's 20. In other words, the output characteristics of the internal power supplies in the adjacent macro's 20 can be considered the same. ACV information can be obtained for a particular technology process, and the suitable number of macro's 20 to include in a grouping can be appropriately determined.

Therefore, in a situation where ACV is not a significant issue, the signal bus V_CTRL[1:n][1:m] will carry one set of “m” power control signals that are received by all the embedded DRAM macro's 20. In such an example, the signal bus would be referred to as V_CTRL[1:m], and all the macro's 20 in the grouping 100 provide their output voltages to the voltage test lines V_LINE[1:m] in parallel. This embodiment can be referred to as the common power control signal testing architecture.

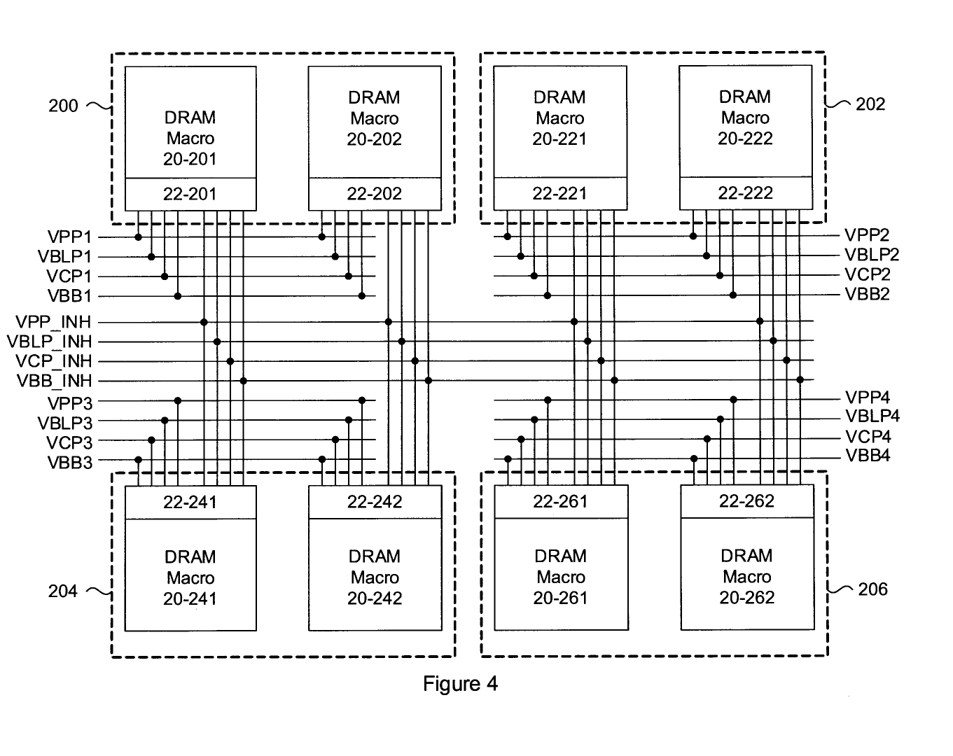

An example implementation of the common power control signal testing architecture embodiment of the present invention is shown in FIG. 4. In the embedded DRAM system of FIG. 4, there are eight embedded DRAM macro's 20 organized into four groupings 200, 202, 204 and 206. Each grouping 200, 202, 204 and 206 includes two embedded DRAM macro's 20. Each embedded DRAM macro 20 has VPP, VBLP, VCP and VBB internal power supplies in their respective internal power supply circuit areas 22. Grouping 200 includes DRAM macro's 20-201 and 20-202 having internal power supply circuit areas 22-201 and 22-202, respectively. Grouping 202 includes DRAM macro's 20-221 and 20-222 having internal power supply circuit areas 22-221 and 22-222, respectively. Grouping 204 includes DRAM macro's 20-241 and 20-242 having internal power supply circuit areas 22-241 and 22-242, respectively. Grouping 206 includes DRAM macro's 20-261 and 20-262 having internal power supply circuit areas 22-261 and 22-262, respectively. As shown in FIG. 4, each grouping shares one common set of bi-directional voltage test lines. For example, grouping 200 has VPP1, VBLP1, VCP1 and VBB1 voltage test lines. A common set of power control signals, VPP_INH, VBLP_INH, VCP_INH and VBB_INH are connected to each internal power supply. Hence during testing, any one or more of the same internal power supplies in all the embedded DRAM macro's 20 can be disabled in parallel by activating the corresponding power control signal(s). An advantage of the common power control signal testing architecture of FIG. 4 is that all embedded DRAM macro's 20 can be tested in parallel.

Therefore, the common power control signal testing architecture of FIG. 4 only requires sixteen voltage test lines and four power control signals with corresponding test pads, for a total of twenty test pads. This number is far less than the worst-case scenario of sixty-four test pads.

In a situation where ACV can affect the output voltages, such as in advanced process technologies, even groupings of two adjacent embedded DRAM macro's 20 can have different output voltages. Hence, it may be desirable to test the output voltages of each embedded DRAM macro 20 in order to obtain finer control and tuning of the power supplies of each embedded DRAM macro 20. Therefore within each grouping, only the internal power supplies of one embedded DRAM macro 20 are enabled, while the internal power supplies of the other embedded DRAM macro's of the group are disabled. Accordingly, for each grouping, there is preferably a corresponding set of power control signals dedicated for disabling the internal power supplies of each embedded DRAM macro 20. With reference to FIG. 3, such a control scheme would have up to “n” sets of “m” power control signals V_CTRL, expressed as V_CTRL[1:n][1:m]. This embodiment can be referred to as the selective power control signal testing architecture.

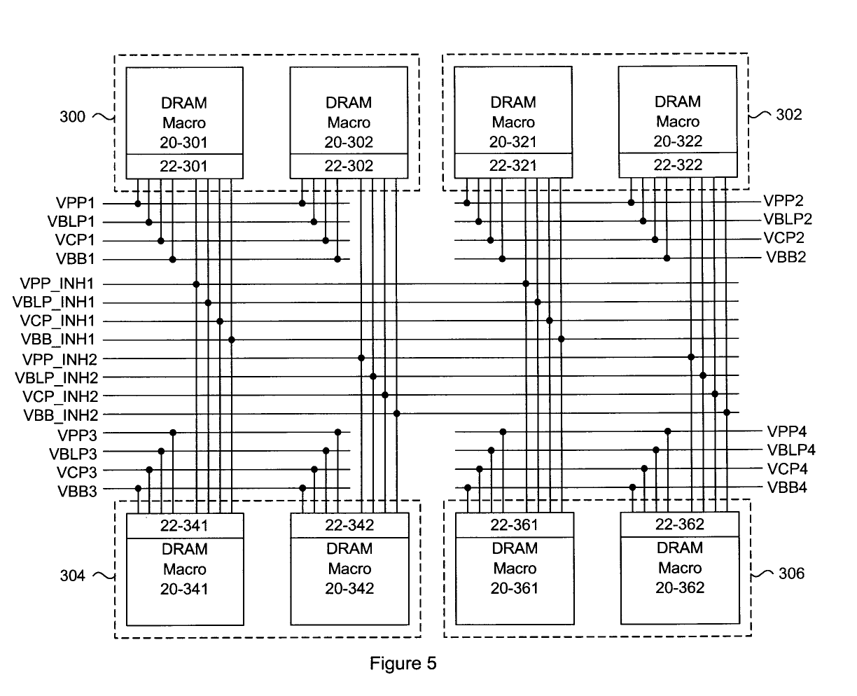

An example implementation of the selective power control signal testing architecture embodiment of the present invention is shown in FIG. 5. In the embedded DRAM system of FIG. 5, there are eight embedded DRAM macro's 20 organized into four groupings 300, 302, 304 and 306. Each grouping 300, 302, 304 and 306 includes two embedded DRAM macro's 20. Each embedded DRAM macro 20 has VPP, VBLP, VCP and VBB internal power supplies in their respective internal power supply circuit areas 22. Grouping 300 includes DRAM macro's 20-301 and 20-302 having internal power supply circuit areas 22-301 and 22-302, respectively. Grouping 302 includes DRAM macro's 20-321 and 20-322 having internal power supply circuit areas 22-321 and 22-322, respectively. Grouping 304 includes DRAM macro's 20-341 and 20-342 having internal power supply circuit areas 22-341 and 22-342, respectively. Grouping 306 includes DRAM macro's 20-361 and 20-362 having internal power supply circuit areas 22-361 and 22-362, respectively. As shown in FIG. 5, each grouping shares one common set of bidirectional voltage test lines, which is identical to the configuration shown for the implementation of FIG. 4. With two embedded DRAM macro's 20 per grouping, two sets of power control signals are required. As shown in FIG. 5, power control signals VPP_INH1, VBLP_INH1, VCP_INH1 and VBB_INH1 are connected to the first embedded DRAM macro 20 in each grouping, while VPP_INH2, VBLP_INH2, VCP_INH2 and VBB_INH2 are connected to the second embedded DRAM macro 20 in each grouping. During testing, any one or more of the same internal power supplies in either of the embedded DRAM macro's 20 of each group can be disabled in parallel. Therefore, exactly one internal power supply has dedicated use of the shared voltage test line.

The advantage of the selective power control signal testing architecture of FIG. 5 is that the internal power supplies of individual embedded DRAM macro's 20 can be tested. Since one embedded DRAM macro 20 of each group can have dedicated use of its common voltage test lines, four embedded DRAM macro's 20 can be tested in parallel. The remaining four embedded DRAM macro's 20 would be tested in a following test cycle. For example, in a first test cycle VPP_INH2, VBLP_INH2, VCP_INH2 and VBB_INH2 can be activated to disable the corresponding internal power supplies of the second embedded DRAM macro's 20 in each grouping. For example, the left side embedded DRAM macro's 20 in each grouping can provide their internal voltages onto the shared voltage test lines. In a following test cycle, VPP_INH1, VBLP_INH1, VCP_INH1 and VBB_INH1 can be activated to disable the corresponding internal power supplies of the first embedded DRAM macro's 20 in each grouping. Hence the right side embedded DRAM macro's 20 in each grouping can provide their internal voltages onto the shared voltage test lines.

Although the selective power control signal testing architecture of FIG. 5 requires a total of twenty-four test pads, this architecture provides high testing flexibility. For example, the selective power control signal testing architecture of FIG. 5 can be controlled to operate in the same manner as the common control signal testing architecture of FIG. 4. This can be done simply by driving the two sets of power control signals with the same signals, such that there is effectively one set of logical power control signals. For example, VPP_INH2 would be the same as VPP_INH1.

It has been previously described that the internal power supplies of one embedded DRAM macro 20 of each grouping can have dedicated access to the common voltage test lines. In an alternate control scheme, different internal power supplies from different embedded DRAM macro's 20 of each grouping can be tested at the same time. Take a situation where VPP_INH1, VCP_INH1, VBLP_INH2 and VBB_INH2 are activated to disable the internal power supplies they are connected to. The left side embedded DRAM macro 20 has its VPP and VCP power supplies disabled, giving the right side embedded DRAM macro 20 dedicated access to the VPP1 and VCP1 lines. The right side embedded DRAM macro 20 has its VBLP and VBB power supplies disabled, giving the left side embedded DRAM macro dedicated access to the VBLP1 and VBB1 lines. Those of skill in the art will understand that different combinations can be obtained.

The previously described embodiments of FIGS. 4 and 5 illustrate embedded DRAM macro groupings where the same internal power supply (ie. VPP power supply) in a grouping share the same voltage test line (ie. VPP1). In an alternate embodiment, each embedded DRAM macro can have all its internal power supplies connected to one common voltage test line. This embodiment can be referred to as the common voltage test line testing architecture.

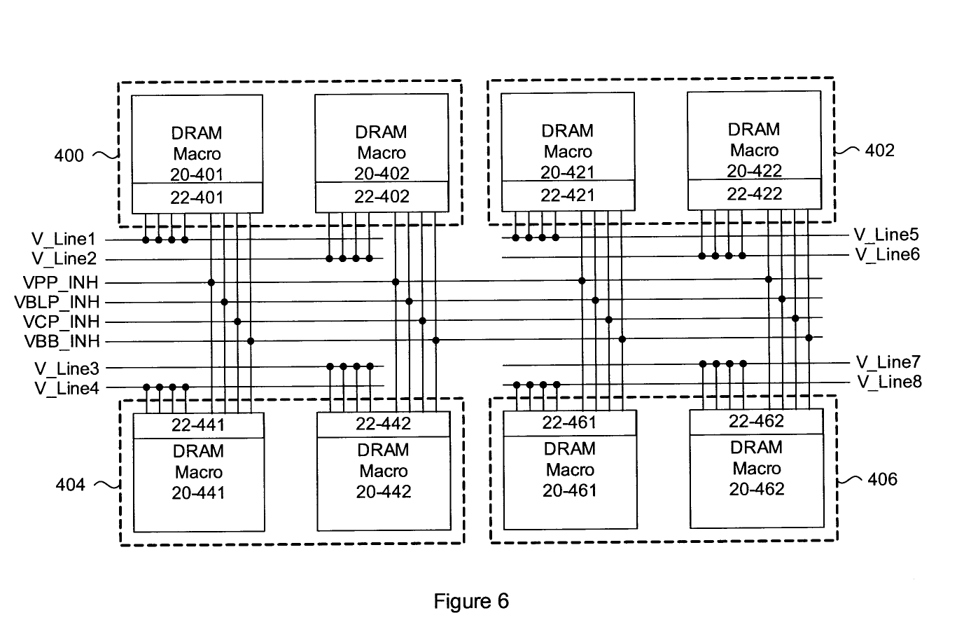

FIG. 6 shows an example implementation of the common voltage test line testing architecture. The embedded DRAM system of FIG. 6 is similar to the ones previously shown in FIGS. 4 and 5. Eight embedded DRAM macro's 20 are organized into four groupings 400, 402, 404 and 406. In the present example, the VPP, VBLP, VCP and VBB internal power supplies of each embedded DRAM macro 20 of one group are connected to respective common voltage test lines. Grouping 400 includes DRAM macro's 20-401 and 20-402 having internal power supply circuit areas 22-401 and 22-402, respectively. Grouping 402 includes DRAM macro's 20-421 and 20-422 having internal power supply circuit areas 22-421 and 22-422, respectively. Grouping 404 includes DRAM macro's 20-441 and 20-422 having internal power supply circuit areas 22-441 and 22-442, respectively. Grouping 406 includes DRAM macro's 20-461 and 20-462 having internal power supply circuit areas 20-461 and 22-462, respectively.

As shown in FIG. 6, the left side embedded DRAM macro 20 has all its internal power supply outputs connected to V_Line1, while the right side embedded DRAM macro 20 has all its internal power supply outputs connected to V_Line 2. In otherwords, each embedded DRAM macro 20 of each grouping has a dedicated voltage test line. A common set of power control signals VPP_INH, VCP_INH, VBLP_INH and VBB_INH are connected to the respective internal power supplies of all the embedded DRAM macro's 20, which is the same configuration as shown for the embodiment of FIG. 4. In the presently shown embodiment, only one internal power supply of each embedded DRAM macro 20 can be tested in parallel. For example, to test the VPP power supplies, VCP_INH, VBLP_INH and VBB_INH would be activated to disable those corresponding internal power supplies of all the embedded DRAM macro's 20. In this particular embodiment, only 12 test pads are required.

It is noted that the output of each internal power supply is directly connected to the respective internal power supplies. Therefore, without further modifications, having all the outputs simply connected to each other via the voltage test line will result in a situation where all the internal power supplies are physically shorted together during normal operation. Accordingly, the presently shown embodiment of FIG. 6 will require isolation means in line between the internal power supply and its connection to the voltage test line (ie. V_Line1), for isolating the internal power supply from the voltage test line. In otherwords, the isolation means functions as a 4:1 multiplexor implemented with gating transistors, controllable by additional selection signals. In combination with the power control signals, any combination of internal power supplies and gating transistors can be turned on or off. If required, the control signals can be set to higher/lower than normal voltage levels for overdriving the gating transistors. Implementations of such a modification should be well known to those skilled in the art.

Those of skill in the art will appreciate that further embodiments can be obtained by combining the previously illustrated and described test architecture embodiments. For example, the common voltage test line testing architecture of FIG. 6 can have all the internal power supplies in a grouping connected to one voltage test line, but two sets of power control signals can be used to control the internal power supplies of each embedded DRAM macro 20 in the groupings.

The previously described embodiments of the invention use embedded DRAM macros as sub-systems. However, any type of integrated sub-system can be used. Furthermore, a combination of different types of sub-systems can be grouped together, instead of the same type of sub-system.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A power supply test architecture for a system having two internal power supplies, comprising:
a bidirectional voltage test line connected to the two power supplies; and
a power control signal for disabling at least one of the two internal power supplies.

2. The power supply test architecture of claim 1, wherein the two internal power supplies are configured for generating identical internal voltages.

3. The power supply test architecture of claim 2, wherein each of the two internal power supplies are integrated in first and second sub-systems.

4. The power supply test architecture of claim 1, wherein the power control signal simultaneously disables the two internal power supplies.

5. The power supply test architecture of claim 1, wherein the power control signal disables one of the two internal power supplies, and another power control signal disables the other of the two internal power supplies.

6. The power supply test architecture of claim 1, wherein the two internal power supplies are configured for generating different internal voltages.

7. The power supply test architecture of claim 6, wherein the two internal power supplies are integrated in a sub-system.

8. The power supply test architecture of claim 7, wherein the power control signal disables one of the two internal power supplies, and another power control signal disables the other of the two internal power supplies.

9. The power supply test architecture of claim 8, further including isolation means for selectively connecting one of the two internal power supplies to the bi-directional voltage test line in response to at least one selection signal.

10. A power supply test architecture comprising:
a plurality of sub-systems, each of the plurality of sub-systems having an internal power supply for providing an internal voltage;
a plurality of voltage test lines, each of the plurality of voltage test lines receiving the internal voltage from corresponding groups of sub-systems; and
a power control signal for disabling at least one of the internal power supplies in the corresponding groups of sub-systems.

11. The power supply test architecture of claim 10, wherein each of the plurality of sub-systems has a second internal power supply for providing a second internal voltage.

12. The power supply test architecture of claim 11, further including
a plurality of second voltage test lines for receiving the second internal voltage from the corresponding groups of sub-systems, and
a second power control signal for disabling the second internal power supplies of the plurality of sub-systems.

13. The power supply test architecture of claim 11, wherein the power control signal disables the internal power supplies of the plurality of sub-systems, and the second power control signal disables the second internal power supplies of the plurality of sub-systems.

14. The power supply test architecture of claim 11, wherein the power control signal disables the internal power supply of one sub-system in each of the corresponding groups of sub-systems, and the second power control signal disables the second internal power supply of the one sub-system in each of the corresponding groups of sub-systems.

15. The power supply test architecture of claim 13, further including
a third power control signal for disabling the internal power supply of another sub-system in each of the corresponding groups of sub-systems, and
a fourth power control signal for disabling the second internal power supply of the another sub-system in each of the corresponding groups of sub-systems.

16. The power supply test architecture of claim 11, wherein each group of sub-systems includes one sub-system.

17. The power supply test architecture of claim 11, wherein each of the plurality of voltage test lines receives the internal voltage and the second internal voltage from one corresponding sub-system, the power supply test architecture further including a second power control signal for disabling the second internal power supplies of the plurality of sub-systems.

18. The power supply test architecture of claim 17, wherein each of the plurality of sub-systems includes isolation means for selectively coupling one of the internal voltage and the second internal voltage to a corresponding voltage test line in response to at least one selection signal.

19. The power supply test architecture of claim 1, wherein the two internal power supplies are included in the system.

20. The power supply test architecture of claim 19, wherein the two internal power supplies are for use in data processing devices.

21. The power supply test architecture of claim 20, wherein the data processing devices comprise dynamic random access memories, flash memories, static random access memories and processors.
